(19) United States
(12) Patent Application Publication
(10) Pub. No.: US 2026/0093793 A1
(43) Pub. Date: Apr. 2, 2026

(54) Apparatus, Systems, and Methods for Controlling Device States based on Consent Indicators

(71) Applicant: Zebra Technologies Corporation, Lincolnshire, IL (US)

(72) Inventor: Daniel Glitto, Clarendon Hills, IL (US)

(21) Appl. No.: 18/902,780

(22) Filed: Sep. 30, 2024

(51) Int. Cl. G06F 21/32; G06F 21/62

(52) U.S. Cl. CPC G06F 21/32; G06F 21/629

(57) ABSTRACT

Apparatus, systems, and methods for controlling device states based on consent indicators are disclosed herein. An example apparatus includes a state controller to manage a state of a device, wherein a first state includes a biometric data function being disabled and an object recognition function being enabled; a second state includes the biometric data function being enabled; and a third state includes the device or an application of the device being unlocked; an indicator detector to, when the device is in the first state, analyze sensor data using the object recognition function to determine whether a user of the device provided an indicator, wherein the state controller is to set the device to the second state in response to the indicator detector detecting the indicator; and an authenticator to, when in the second state, perform the biometric data function to determine whether the user is authorized to use the device.

### BACKGROUND

Computing devices may be enabled with biometric recognition for identification or authentication requests to biometrically identify or authenticate approved users to access the device or certain applications on the device. However, running biometric analysis continuously is computationally expensive and may create risks associated with privacy concerns.

### BRIEF DESCRIPTION OF THE SEVERAL VIEWS OF THE DRAWINGS

The accompanying figures, where like reference numerals refer to identical or functionally similar elements throughout the separate views, together with the detailed description below, are incorporated in and form part of the specification, and serve to illustrate embodiments of concepts that include systems, methods, and apparatus disclosed herein, and explain various principles and advantages of those embodiments.

FIG. 1 is a schematic diagram of an example device including a state controller, an indicator detector, and an authenticator constructed in accordance with teachings of this disclosure for selectively enabling biometric recognition.

FIG. 2 is a flowchart of example operations that may be executed to implement the example state controller, indicator detector, and authenticator of FIG. 1.

FIGS. 3A-C are diagrams of example detections by the example indicator detector.

FIGS. 4A and 4B are diagrams of example detections by the example authenticator.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention. The apparatus and method components have been represented where appropriate by conventional symbols in the drawings, showing only those specific details that are pertinent to understanding the disclosure provided herein so as not to obscure the description with details that will be readily apparent to those of ordinary skill in the art having the benefit of the description herein.

### DETAILED DESCRIPTION

Many computing devices are configured to verify an identity of a user as a condition of unlocking the device (e.g., for personal use or when arriving to a place of employment and selecting a mobile computer from a workforce fleet) or a specific application or feature of the device. If the identification method involves the use of information representative of one or more biometric characteristics of the user (e.g., fingerprint, facial features, voiceprint, retinal features), such data must be collected, generated, and/or analyzed. However, collection or generation of biometric information involves ethical and/or, in some states or countries, regulatory concerns with respect to privacy rights. Moreover, collection, generation, and analysis of biometric data is computationally expensive and demanding of system resources.

Example systems, methods, and apparatus disclosed herein control a state of a device to verify an identity of a user in a logistically and computationally efficient manner that restricts collection or generation of biometric data unless and until a user provides express consent, thereby respecting privacy rights, complying with related rules and regulations, and reducing the impact of computationally expensive functions associated with biometric data-based user identification, such as facial recognition and fingerprint analysis. Examples disclosed herein achieve these benefits by efficiently controlling the state of a device to allow, for example, usage of image data as part of the user identification process—a preferred method of unlocking a device for many users—while simultaneously restricting the use of biometric data functions (until consent is provided), thereby minimizing the amount of time such functions and the associated hardware are active which is beneficial for resource conservation, battery life, and component availability.

As described in detail below, an example state controller disclosed herein places a computing device into a first state in which collection or generation of biometric data is disabled (e.g., facial recognition and/or fingerprint sensing is inactivated). When in the first state, the example state controller enables applications and/or components, such as an image sensor and associated object recognition functions capable of recognizing an object in image data, to obtain a consent indicator from a user (e.g., a thumbs-up gesture or a printed symbol). Notably, in this example, detecting the consent indicator actively and purposefully excludes any function or feature that can identify a particular person. The example state controller disclosed herein maintains the device in the first state until the consent indicator is detected. When such an indicator is detected, the example state controller places the device in a second state in which collection and/or analysis of biometric data is enabled and can be utilized to verify the identity of the user. If the user is determined to be authorized to use the device, the example state controller disclosed herein unlocks the device or, if the device is already unlocked, grants access to a specific application or feature that requires biometric data authentication.

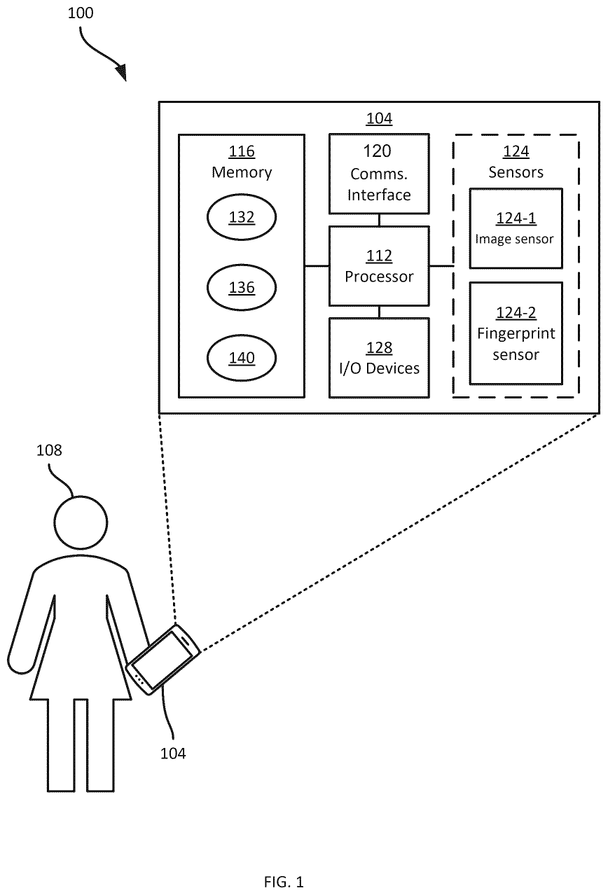

Turning to the drawings, FIG. 1 depicts an example computing device 104 including an example state controller 132, consent detector 136, and authenticator 140 configured in accordance with the teachings of this disclosure. In the illustrated example of FIG. 1, the device 104 is a mobile computing device, such as a smart phone, tablet, laptop, a handheld barcode scanner, or the like. In other examples, the device 104 is a fixed computing device, such as a desktop computer, a kiosk, a fixed camera or fingerprint reader deployed in an environment including devices for which authentication is required, or the like.

As described in detail below, the example state controller 132 defines and manages a set of states for the device 104, the example consent detector 136 of FIG. 1 is configured to detect a consent indicator (e.g., a gesture or printed symbol indicating that the user 108 consents to the use of biometric data to identify the user 108 as a particular person) using an object recognition function (e.g., an image recognition function) that does not allow the identification of a particular individual, and the authenticator 140 utilizes one or more biometric data functions to identify a person based on collected or generated biometric data, such as facial recognition, fingerprint recognition, or voiceprint analysis.

The example device 104 of FIG. 1 includes a processor 112, a memory 116, a communications interface 120, one or more sensors 124, and one or more additional input and/or output devices 128.

The processor 112 includes any suitable logic circuit, such as a central processing unit (CPU), microprocessor, microcontroller, multiple cooperating processors, application specific integrated circuit, or field programmable gate array. The processor 112 is interconnected with memory 116, which is implemented by a non-transitory computer-readable storage medium. The memory 116 may include a combination of volatile memory (e.g., Random Access Memory or RAM) and non-volatile memory (e.g., read only memory or ROM, Electrically Erasable Programmable Read Only Memory or EEPROM, flash memory). The processor 112 and the memory 116 may each comprise one or more logic circuits.

The memory 116 stores computer-readable instructions for execution by the processor 112. In particular, the memory 116 stores a plurality of applications, which when executed by the processor 112, configure the processor 112 to perform the various functions discussed below in greater detail. Specifically, the memory 116 stores the state controller 132, the indicator detector 136, and the authenticator 140.

The communications interface 120 enables the device 104 to exchange data with, for example, other computing devices. The communications interface 120 is interconnected with the processor 112 and includes hardware (e.g., transmitters, receivers, network interface controllers) configured to communicate with other computing devices.

The example device 104 of FIG. 1 includes one or more sensors 124, of which an image sensor 124-1 and a fingerprint sensor 124-2 are depicted. The sensors 124 may additionally or alternatively include audio sensors (e.g., microphones), touch sensors (e.g., touch-sensitive displays), light sensors, or temperature sensors. In the illustrated example, the sensors 124 are configured to capture sensor data for analysis by the indicator detector 136 and the authenticator 140. In the present example, the sensors 124 are illustrated as integrated with the device 104. In other examples, the sensors 124 may be external to the device 104 and the device 104 may be in communication with the sensors 124 to obtain the sensor data from the sensors 124.

One or more of the sensors 124 may be integrated with the I/O devices 128. For example, the I/O devices 128 may include one or more buttons, keypads, or touch-sensitive display screens for receiving input from the user 108, some or all of which may operate as or embody the sensors 124 from which the sensor data is obtained to be analyzed by the indicator detector 136 and the authenticator 140. The I/O devices 128 may include one or more display screens, sound generators, or vibrators for providing output or feedback to the user 108.

The example state controller 132 of FIG. 1 manages the state of the device 104 and, therefore, whether certain functions are enabled at a particular time, including the object recognition function of the indicator detector 136 and the biometric data function of the authenticator 140. Specifically, the state controller 132 defines and implements a first state for the device 104 in which the biometric data function of the authenticator 140 is disabled and the object recognition function of the indicator detector 136 is enabled. In some examples, the first state includes the device 104 being locked (e.g., without any access having been granted). Alternatively, the first state may be implemented while the device 104 is unlocked to allow access to certain applications or features, but also restrictive with respect to certain applications or features until a biometric authentication is provided (e.g., when certain applications or features require biometric authentication to allow access thereto).

The example state controller 132 of FIG. 1 defines and implements a second state in which the biometric data function of the authenticator 140 is enabled and the device 104 and/or certain application(s) or features(s) are locked. The example state controller 132 of FIG. 1 defines and implements a third state in which the device 104 is fully unlocked (e.g., by changing a setting in an operating system) to allow access to all applications and features or unlocked with respect to a subset of applications or features of the device 104 that required a successful biometric authentication (e.g., depending on an access profile associated with the user 108).

In some examples, the state controller 132 obtains location information indicative of a geographic location of the device 104 (e.g., via a global positioning system) and implements all or a subset of the first, second, and third states based on the geographic location. Because privacy rules or regulations or policies of an organization may vary among states, countries, or regions, the example state controller 132 of FIG. 1 enables users or administrators to selectively activate one or more of the states described above. For example, the state controller 132 may be configured to not implement the first state when the device 104 is determined to be located in a state or jurisdiction in which an organization is not required to obtain consent for collecting or generating biometric information for purposes of identifying a person, and, instead, place the device 104 in the second state when locked. In such examples, the user 108 may be identified using the biometric data function without first having to provide a consent indicator. On the other hand, the state controller 132 may use geographic location information to activate and implement the first state such that the consent indicator is required in response to determining that the device 104 is located in a state or jurisdiction that requires consent for collecting or generating biometric data for purposes of identifying a person.

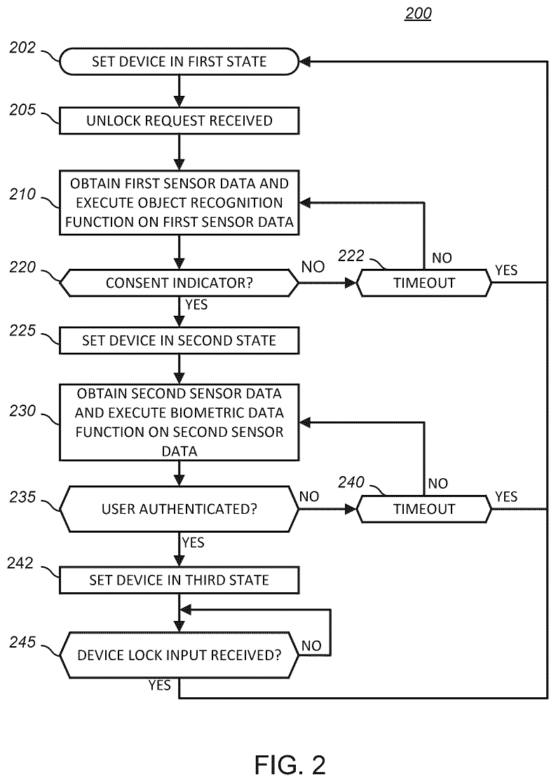

As described in detail below in connection with FIG. 2, the state controller 132 transitions the device 104 from the first state to the second state based on an output generated by the object recognition function of the indicator detector 136 (e.g., a detection of a consent indicator), and from the second state to the third state based on an output generated by the biometric data function of the authenticator 140 (e.g., that the user 108 is an individual that is authorized to use the device 104 or a particular application or feature thereof).

The example indicator detector 136 of FIG. 1 searches for pre-defined indicators in sensor data obtained by one of the sensors 124. In the illustrated example of FIG. 1, the indicator detector 136 performs the object recognition function on image data obtained by the image sensor 124-1. The object recognition function implemented by the example indicator detector 136 of FIG. 1 determines whether the pre-defined consent indicators (e.g., a gesture, such as thumbs-up or “OK”, or a printed symbol, such as a green check mark or a code printed on a badge) are present in the sensor data using an analysis that is trained to find and/or decode the consent indicators. Notably, the example indicator detector 136 of FIG. 1 is programmed or configured to not personally identify individuals, such as the user 108. That is, the example indicator detector 136 of FIG. 1 does not collect, generate, or apply biometric characteristic recognition or identify or recognize biometric features. Accordingly, the device 104 is unable to collect, generate, or use biometric data associated with the user 108 without the user 108 having provided a consent indicator.

In the illustrated example, the authenticator 140 is restricted and configured to be disabled unless and until the device 104 is set to the second state by the state controller 132. After a consent indicator has been detected (causing the state controller 132 to transition the device 104 to the second state), the example authenticator 140 of FIG. 1 applies biometric analysis on sensor data to uniquely identify an individual by, for example, recognizing or identifying biometric features or characteristics of the user 108 (e.g., based on a library or database of biometric features or characteristics known to correspond to a particular individual). In the example of FIG. 1, the biometric data function includes facial recognition, fingerprint recognition, or other recognition of uniquely identifying biometric features to determine whether the user 108 is authorized to use the device 104. In some examples, the sensor data analyzed by the authenticator 140 and the indicator detector 136 may be the same sensor data or the same type of sensor data, however the authenticator 140 is selectively enabled depending on detection of a consent indicator in the sensor data by the indicator detector 136.

The example state controller 132 places the device 104 in the third state in response to the authenticator 140 determining that the user 108 is a specific person that has been granted authorization (e.g., by the user 108 or an administrator of workplace information technology system) to use the device 104 or a particular application or feature. When in the third state, the entire device 104 or a subset of features or applications is unlocked for the user 108 to interact with or use. In some examples, the authenticator 140 obtains an access profile associated with the identified user 108 and provides access to a particular set of applications or features (e.g., based on a role of the user 108 in an organization).

The state controller 132, the indicator detector 136, and the authenticator 140 are illustrated in the present example as a suite of distinct applications, but in other examples, one or more of the state controller 132, the indicator detector 136, and the authenticator 140 may be integrated.

FIG. 2 is a flowchart illustrative of an example method implemented by the example state controller 132, the example indicator detector 136, and the example authenticator 140, and/or, more generally, the example device 104 of FIG. 1. While the example method 200 of FIG. 2 is discussed in conjunction with the example state controller 132, the indicator detector 136, and the authenticator 140 of FIG. 1, the example method 200 may be performed by other suitable devices or systems configured in accordance with teachings of this disclosure.

The method 200 is initiated at block 202, in which the state controller 132 sets the device 104 to the first state, in which the biometric data function of the authenticator 140 is disabled, the object recognition function of the indicator detector 136 is enabled, and the device 104 is locked (e.g., against the user 108 having access to some or all features or applications of the device 104). For example, the device 104 may be set in the first state when the device 104 has been actively locked by user input (e.g., pressing a lock button) or after a predefined timeout period for usage of the device 104.

At block 205, the device 104 detects an unlock request. For example, the unlock request may be a request to gain access to all applications of the device 104 (e.g., using biometrics), to access certain restricted or confidential information or applications (e.g., using biometrics), or to identify the user 108 via biometrics to associate an account of the user 108 to the device 104. In some examples, the unlock request may be explicitly requested, such as by turning on a screen of the device 104, moving the device 104 in a particular orientation, or opening a specific secured application or file or the like. In other examples, the unlock request may be implicit, such as by detection of non-identifying characteristic of the user 108, such as a silhouette of the user's 108 head or pressure and/or input on a fingerprint sensor (without acquiring and analyzing the data to recognize the user's fingerprint).

At block 210, in response to the unlock request, the indicator detection 136 obtains first sensor data using, for example, the image sensor 124-1. The image sensor 124-1 may be a predefined sensor designated for detecting the consent indicator. In some examples, the image sensor 124-1 may correspond to the same sensor from which the unlock request originated. In some examples, the device 104 may obtain the first sensor data from a sensor external to the device 104. In some examples, the I/O devices 128 provide a prompt to the user 108 to provide a consent indicator by, for example, displaying a visual notification or generating an audio cue. In some examples, the prompt provides examples of acceptable consent indicators and/or may provide an alternative option (e.g., by displaying options for the user to confirm or decline consent) for providing consent and/or the indicator.

Also at block 210, the indicator detector 136 executes an object recognition function to determine whether a consent indicator is detected in the first sensor data. In the illustrated example, the indicator detector 136 applies an object recognition function or detection analysis to the first sensor data that is incapable of identifying a particular person. For example, the recognition or detection function may include object detection to identify a predefined consent-indicating symbol on an identification card or badge, such as a barcode or checkmark of a particular color. In some examples, the recognition or detection function applies gesture detection and analysis to detect a certain gesture, such as a thumbs-up or “OK” gesture. In other examples, other consent indicators may also be detected, such as affirmatively answering a consent question displayed on the device 104 or by pressing a button or touch-sensitive screen or the like.

If the consent indicator is not detected (block 220), the indicator detector 136 determines if a timeout period has elapsed, at block 222. If so, the indicator detector 136 ceases the determination of whether a consent indicator was provided, and the method returns to block 202. If the timeout period has not elapsed, the indicator detector 136 continues obtaining and analyzing the first sensor data to determine if a consent indicator is detected. The device 104 may additionally delete the first sensor data used for the object recognition function to be deleted while the device 104 is in the first state without using the collected data for the biometric data function (i.e., for personal identification purposes).

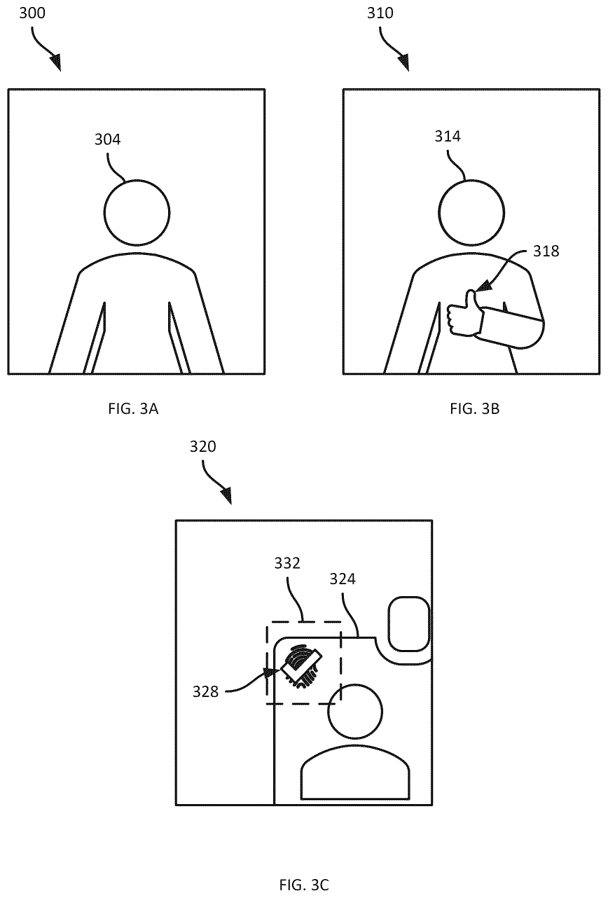

Referring to FIG. 3A, which depicts example image data 300 collected at block 210 by the image sensor 124-1 as the first sensor data, the objection recognition function applied by the indicator detector 136 (i.e., a limited analysis limited such that a user is not identifiable by, for example, identifying inter-pupil distances and other unique facial structure features) determines that the mere silhouette 304 of the user is not sufficient as a consent indicator to transition the device 104 to the second state. Accordingly, the method 200 continues to iterate through blocks 222 and 210.

Referring to FIG. 3B, which depicts example image data 310 collected at block 210 by the image sensor 124-1 as the first sensor data, the indicator detector 136 recognizes a silhouette 314 of a user and a thumbs-up gesture 318. Notably, the indicator detector 136 is configured to recognize the gesture in a manner that allows the user to remain unidentifiable via biometric data, as the user 108 has not provided consent to collect the same.

Referring to FIG. 3C, which depicts example image data 320 collected at block 210 by the image sensor 124-1, the image data 320 represents an employee or personnel badge 324 having a specific predefined symbol 328 printed thereon. The indicator detector 136 may identify the symbol 328 as a consent indicator. In some examples, to further validate the detection of the symbol 328 as a consent indicator, the indicator detector 136 requires that the symbol 328 is aligned with a certain orientation, such as centered and sufficiently large within the frame of view of the image sensor 124-1. Upon detecting the symbol 328 within the frame of view of the camera 124-1 more generally, the I/O devices 128 may display a target window 332 on the display screen to illustrate the region of the frame of view of the camera 124-1 in which to center the symbol 328. In other examples, the indicator detector 136 may validate other conditions, such as the orientation of the badge 324, a sequence of symbols 328, or suitable conditions to reduce the likelihood that the symbol 328 was detected by the camera 124-1 inadvertently, rather than as an explicit consent indicator.

Returning to FIG. 2, if the indicator detector 136 detects a consent indicator in the first image data obtained and analyzed at block 210, then the example method 200 proceeds to block 225. At block 225, the state controller 132 updates the device 104 to the second state to enable the biometric data function of the authenticator 140. For example, the state controller 132 may update a local cache or a repository stored in the memory 116 to set the device 104 to the second state. The second state may be associated with a particular source application from which the unlock request originated or the second state may apply device wide. In the illustrated example, upon detecting the consent indicator, the state controller 132 initiates a timer associated with the second state for a predefined consent duration indicating how long the second state is valid for (e.g., 30 seconds, 1 minute, 5 minutes, etc.). The length of the consent duration may vary, for example based on the geographic location of the device, the particular application of the unlock request, or specific device and/or application settings.

At block 230, the authenticator 138 obtains second sensor data from a second sensor 124. The second sensor data is data suitable for applying recognition analysis by the authenticator 140, from which biometric features may be recognized to uniquely identify the individual user 108. The second sensor 124 may be the same sensor as the first sensor 124 and further, the second sensor data may be the same as the first sensor data obtained at block 210. Alternatively, the second sensor 124 may be independent of the first sensor 124. For example, the second sensor 124 may be a predefined sensor (e.g., the fingerprint sensor 124-2) designated for obtaining biometric data. In other examples, the second sensor 124 may correspond to the sensor 124 from which the authentication request originated. In still further examples, the authenticator 138 may obtain respective sensor data from a plurality of second sensors 124 on which to apply the biometric data function to identify biometric features of the user to satisfy the authentication process.

The authenticator 138 determines whether the second sensor data obtained at block 230 is sufficient to perform the biometric data function and, if so, executes the biometric data function. For example, the biometric data function may include fingerprint detection, facial recognition, or voice recognition.

If the authenticator determines that the user 108 is not authenticated (block 235), the authenticator 138, at block 240, confirms that the consent duration remains active (i.e., has not yet timed out), or that the second state otherwise remains valid (i.e., the biometric data function remains enabled).

If the consent duration remains active (block 240), then the authenticator 138 obtains additional second sensor data. If the consent duration times out or until some other factor otherwise restricts or disables the biometric data function (i.e., to move the device 104 out of the second state), the example method 200 proceeds to block 202 and the state controller 132 places the device 104 in the first state. In some examples, the device 104 may display or otherwise provide an indication of the expiry of the consent duration.

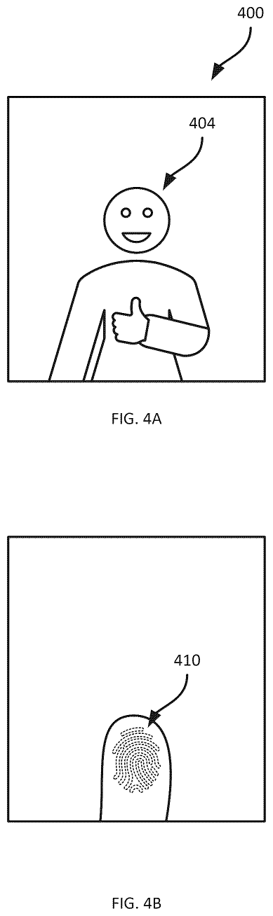

Referring to FIG. 4A, which depicts example image data obtained as the second sensor data 400 at block 230, the authenticator 138 may detect a location in the image corresponding to the face 404, including the eyes and mouth of the user and compare the image data and biometric features found at those locations to the biometric features of an approved list of users, such as the user 108 and/or coworkers of the user 108. Upon matching the biometric features of the face 404 to those of one of the approved users (block 235), the authenticator 138 generates an indication that the user 108 is identified as an authorized user of the device 104 and/or an application or features for which the unlock request was received.

Referring to FIG. 4B, which depicts example second sensor data obtained at block 230 from the fingerprint sensor 124-2, the authenticator 138 executes the biometric data function on the second sensor data in accordance with the type of the data (i.e., fingerprint data). That is, the image sensor 124-1 may function as the first sensor to obtain the first sensor data in the example of method 200, on which only non-identifying detection analysis is performed, while the fingerprint sensor 124-2 may function as the second sensor to obtain the second sensor data, on which the biometric data function is performed. In such examples, any inputs detected by the fingerprint sensor 124-2 prior to detecting the consent indicator by the camera 124-1 may not be recorded or may not be analyzed by the authenticator 140. For example, detection of inputs at the fingerprint sensor 124-2 may prompt the device 104 to request and/or remind the user that the consent indicator is required prior to utilizing the fingerprint sensor 124-2 and enabling the fingerprint analysis.

After detecting the consent indicator and capturing the fingerprint data 410, the authenticator 138 compares the fingerprint data 410 to identify biometric features of the fingerprint, such as various valleys, ridges, and the like, against the biometric features of an approved list of users, such as the user 108 or coworkers of the user 108. Upon matching the biometric features of the fingerprint data 410 to those of one of the approved users, the authenticator 138 generates an indication that the user 108 is identified as an authorized user of the device 104 and/or an application or features for which the unlock request was received.

Returning to FIG. 2, if the determination at block 235 is affirmative, that is, the biometric features identified at block 230 are recognized as being approved, then the process proceeds to block 242 and the state controller 132 places the device 104 in the third state by, for example, unlocking the device 104 and/or enabling access to certain files, applications, or features associated with the unlock request. In some examples, placing the device 104 in the third state includes granting an access level to corresponding to a profile associated with the user 108. For example, the profile may include a partition identification identifying a partition of the device 104 for which to grant access to the user 108.

In example method 200, if an input is received indicating that the device 104 or an application or feature should be locked (e.g., by pressing a button or timing out) (block 245), the state controller 132 places the device 104 in the first state (block 202).

In the foregoing specification, specific embodiments have been described. However, one of ordinary skill in the art appreciates that various modifications and changes can be made without departing from the scope of the disclosure. Accordingly, the specification and figures are to be regarded in an illustrative rather than a restrictive sense, and all such modifications are intended to be included within the scope of present teachings.

The above description refers to block diagrams of the accompanying drawings. Alternative implementations of the examples represented by the block diagrams include one or more additional or alternative elements, processes and/or devices. Additionally or alternatively, one or more of the example blocks of the diagrams may be combined, divided, re-arranged or omitted. Components represented by the blocks of the diagrams are implemented by hardware, software, firmware, and/or any combination of hardware, software and/or firmware. In some examples, at least one of the components represented by the blocks is implemented by a logic circuit. As used herein, the term “logic circuit” is expressly defined as a physical device including at least one hardware component configured (e.g., via operation in accordance with a predetermined configuration and/or via execution of stored machine-readable instructions) to control one or more machines and/or perform operations of one or more machines. Examples of a logic circuit include one or more processors, one or more coprocessors, one or more microprocessors, one or more controllers, one or more digital signal processors (DSPs), one or more application specific integrated circuits (ASICs), one or more field programmable gate arrays (FPGAs), one or more microcontroller units (MCUs), one or more hardware accelerators, one or more special-purpose computer chips, and one or more system-on-a-chip (SoC) devices. Some example logic circuits, such as ASICs or FPGAs, are specifically configured hardware for performing operations (e.g., one or more of the operations represented by the flowcharts of this disclosure). Some example logic circuits are hardware that executes machine-readable instructions to perform operations (e.g., one or more of the operations represented by the flowcharts of this disclosure). Some example logic circuits include a combination of specifically configured hardware and hardware that executes machine-readable instructions.

The above description refers to flowcharts of the accompanying drawings. The flowcharts are representative of example methods disclosed herein. In some examples, the methods represented by the flowcharts implement the apparatus represented by the block diagrams. Alternative implementations of example methods disclosed herein may include additional or alternative operations. Further, operations of alternative implementations of the methods disclosed herein may combined, divided, re-arranged or omitted. In some examples, the operations represented by the flowcharts are implemented by machine-readable instructions (e.g., software and/or firmware) stored on a medium (e.g., a tangible machine-readable medium) for execution by one or more logic circuits (e.g., processor(s)). In some examples, the operations represented by the flowcharts are implemented by one or more configurations of one or more specifically designed logic circuits (e.g., ASIC(s)). In some examples the operations of the flowcharts are implemented by a combination of specifically designed logic circuit(s) and machine-readable instructions stored on a medium (e.g., a tangible machine-readable medium) for execution by logic circuit(s).

As used herein, each of the terms “tangible machine-readable medium,” “non-transitory machine-readable medium” and “machine-readable storage device” is expressly defined as a storage medium (e.g., a platter of a hard disk drive, a digital versatile disc, a compact disc, flash memory, read-only memory, random-access memory, etc.) on which machine-readable instructions (e.g., program code in the form of, for example, software and/or firmware) can be stored. Further, as used herein, each of the terms “tangible machine-readable medium,” “non-transitory machine-readable medium” and “machine-readable storage device” is expressly defined to exclude propagating signals. That is, as used in any claim of this patent, none of the terms “tangible machine-readable medium,” “non-transitory machine-readable medium,” and “machine-readable storage device” can be read to be implemented by a propagating signal.

As used herein, each of the terms “tangible machine-readable medium,” “non-transitory machine-readable medium” and “machine-readable storage device” is expressly defined as a storage medium on which machine-readable instructions are stored for any suitable duration of time (e.g., permanently, for an extended period of time (e.g., while a program associated with the machine-readable instructions is executing), and/or a short period of time (e.g., while the machine-readable instructions are cached and/or during a buffering process)).

Although certain example apparatus, methods, and articles of manufacture have been disclosed herein, the scope of coverage of this patent is not limited thereto. On the contrary, this patent covers all apparatus, methods, and articles of manufacture fairly falling within the scope of the claims of this patent.

What is claimed is:

1. A method comprising:
setting a device in a first state by disabling a biometric data function and enabling an object recognition function;
while the device is in the first state:
analyzing sensor data using the object recognition function, and
determining, based on the analyzed sensor data, whether a user of the device provided an indicator;
in response to detecting the indicator:
setting the device in a second state by enabling the biometric data function, and
performing the biometric data function to determine whether the user is authorized to use the device; and
in response to determining the user is authorized to use the device, setting the device in a third state.

2. The method of claim 1, further comprising determining a geographic location of the device, wherein setting the device in the first state is responsive to the geographic location being associated with a requirement to obtain consent from users prior to collecting or using biometric data.

3. The method of claim 1, wherein setting the device in the third state includes unlocking the device.

4. The method of claim 1, wherein setting the device in the third state includes granting access to a locked application or feature.

5. The method of claim 1, wherein the object recognition function is incapable of identifying the user as a particular person.

6. The method of claim 1, wherein disabling the biometric data function comprises restricting an application from analyzing the sensor data for personal identification purposes.

7. The method of claim 1, wherein disabling the biometric data function comprises disabling a fingerprint analysis at a fingerprint sensor.

8. The method of claim 6, further comprising, in response to detecting an input at the fingerprint sensor while in the first state, issuing a request at the device for the user to provide the indicator to enable the fingerprint analysis of the fingerprint sensor.

9. The method of claim 1, wherein the indicator is a gesture.

10. The method of claim 1, wherein the indicator is a printed symbol.

11. An apparatus comprising:
a state controller to manage a state of a device, wherein:
a first state includes a biometric data function being disabled and an object recognition function being enabled;
a second state includes the biometric data function being enabled; and
a third state includes the device or an application of the device being unlocked;
an indicator detector to, when the device is in the first state, analyze sensor data using the object recognition function to determine whether a user of the device provided an indicator, wherein the state controller is to set the device to the second state in response to the indicator detector detecting the indicator; and
an authenticator to, when in the second state, perform the biometric data function to determine whether the user is authorized to use the device, wherein the state controller is to set the device to the third state in response to the authenticator determining that the user is authorized to use the device, and at least one of the state controller, the indicator detector, and the authenticator is implemented by a logic circuit.

12. The apparatus of claim 11, wherein the state controller is to determine a geographic location of the device, and setting the device in the first state is responsive to the geographic location being associated with a requirement to obtain consent from users prior to collecting or using biometric data.

13. The apparatus of claim 11, wherein the state controller is to set the device to the third state by granting an access level corresponding to a profile associated with the user.

14. The apparatus of claim 11, wherein the object recognition function is incapable of identifying the user as a particular person.

15. The device of claim 11, wherein the biometric data function being disabled comprises being restricted from analyzing the sensor data for personal identification purposes.

16. The device of claim 11, wherein the biometric data function being disabled comprises sensor data used for the object recognition function being deleted without using the collected data for the biometric data function.

17. The device of claim 11, wherein the biometric data function being disabled comprises a fingerprint analysis at a fingerprint sensor being disabled.

18. The device of claim 17, further comprising an output device to output a request for the user to provide the indicator to enable the fingerprint analysis at the fingerprint sensor in response to detecting an input at the fingerprint sensor.

19. The device of claim 11, wherein the indicator is a gesture.

20. The device of claim 11, wherein the indicator is a printed symbol.

21. A tangible machine-readable medium comprising instructions that, when executed, cause a device to at least:
set a device in a first state by disabling a biometric data function and enabling an object recognition function;
while the device is in the first state:
analyze sensor data using the object recognition function, and
determine, based on the analyzed sensor data, whether a user of the device provided an indicator;
in response to detecting the indicator:
set the device in a second state by enabling the biometric data function, and
perform the biometric data function to determine whether the user is authorized to use the device; and
in response to determining the user is authorized to use the device, set the device in a third state.

22. The tangible machine-readable medium of claim 21, wherein the instructions, when executed, cause the device to determine a geographic location of the device, wherein setting the device in the first state is responsive to the geographic location being associated with a requirement to obtain consent from users prior to collecting or using biometric data.

23. The tangible machine-readable medium of claim 21, wherein setting the device in the third state includes unlocking the device.

24. The tangible machine-readable medium of claim 21, wherein setting the device in the third state includes granting access to a locked application or feature.

25. The tangible machine-readable medium of claim 21, wherein the object recognition function is incapable of identifying the user as a particular person.

26. The tangible machine-readable medium of claim 21, wherein disabling the biometric data function comprises restricting an application from analyzing the sensor data for personal identification purposes.

27. The tangible machine-readable medium of claim 21, wherein disabling the biometric data function comprises disabling a fingerprint analysis at a fingerprint sensor.

28. The tangible machine-readable medium of claim 27, wherein the instructions, when executed, cause the device to, in response to detecting an input at the fingerprint sensor while in the first state, issue a request at the device for the user to provide the indicator to enable the fingerprint analysis of the fingerprint sensor.

29. The non-transitory machine-readable medium of claim 21, wherein the indicator is a gesture.

30. The tangible machine-readable medium of claim 21, wherein the indicator is a printed symbol.
